(19) United States
(12) Patent Application Publication
(10) Pub. No.: US 2025/0363689 A1
(43) Pub. Date: Nov. 27, 2025

(54) GENERATIVE INPAINTING UTILIZING SOURCE INPUTS WITH INTELLIGENT BOUNDS

(71) Applicant: Adobe Inc., San Jose, CA (US)

(72) Inventors: Alan L. Erickson, Highlands Ranch, CO (US); Yuqian Zhou, Seattle, WA (US)

(21) Appl. No.: 18/920,088

(22) Filed: Oct. 18, 2024

Related U.S. Application Data
(60) Provisional application No. 63/650,373, filed on May 21, 2024.

(51) Int. Cl. G06T 11/60; G06F 3/04845; G06T 11/40

(52) U.S. Cl. CPC G06T 11/60; G06F 3/04845; G06T 11/40

(57) ABSTRACT

The present disclosure relates to systems, methods, and non-transitory computer-readable media that intelligently resize fill regions when generating content for a digital image. For instance, in one or more embodiments, the disclosed systems identify a fill region for a digital image. The disclosed systems intelligently deriving source image bounds based on one or more parameters of a generative model. Furthermore, the disclosed systems generate, utilizing the generative model, a content fill from the source image bounds and the digital image. The disclosed systems resize the content fill and generate a modified digital image including the resized content fill in a location of the fill region of the digital image.

### CROSS-REFERENCE TO RELATED APPLICATIONS

This application claims priority to and the benefit of U.S. Provisional Patent Application No. 63/650,373, filed on May 21, 2024, which is incorporated herein by reference in its entirety.

### BACKGROUND

Recent years have seen significant advancement in hardware and software platforms for editing digital images. Indeed, as the use of digital images has become increasingly ubiquitous, systems have developed to facilitate the manipulation of the content within such digital images. To illustrate, some systems leverage artificial intelligence to generate content within a digital image, such as through inpainting, outpainting, or generating entirely new objects or scenery for portrayal within a digital image.

### SUMMARY

One or more embodiments described herein provide benefits and/or solve one or more problems in the art with systems, methods, and non-transitory computer-readable media by generating content for a digital image utilizing deep learning and source inputs with intelligent bounds. For example, in one or more embodiments, a system receives an indication of a fill region for a digital image in which to generate content. The system intelligently derives, from the indicated fill region, source image bounds (e.g., a boundary) that will result in high quality generated content when provided as an input to a generative model. For example, the system modifies the bounds of the indicated fill region to have one or more of a size that provides sufficient context to the generative model for content generation, a size that meets an input requirement of the generative model, or a size that helps ensure that the generated content will have high-quality resolution and sharpness. In one or more embodiments, the system utilizes the fill region with intelligently modified bounds and the digital image to generate content utilizing a generative model. The system combines the generated content with the digital image to generate a modified digital image.

Additional features and advantages of one or more embodiments of the present disclosure are outlined in the description which follows, and in part will be obvious from the description, or are learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an intelligent bounds content generation system operates in accordance with one or more embodiments;

FIG. 2 illustrates the intelligent bounds content generation system generating a modified digital image with generated content in accordance with one or more embodiments;

FIGS. 3A-3C illustrate the intelligent bounds content generation system generating a modified digital image having a generated content portion in response to user input received from a client device in accordance with one or more embodiments;

FIG. 4 illustrates the intelligent bounds content generation system generating a modified digital image having a generated content portion using a deep learning based generative model in accordance with one or more embodiments;

FIGS. 5A-5C illustrate the intelligent bounds content generation system generating a bounding box around a user indicated fill region, expanding the bounding box, and adjusting an aspect ratio of the expanded bounding box in accordance with one or more embodiments;

FIG. 6 illustrates the intelligent bounds content generation system resizing the expanded bounding box of FIG. 5C, generating a content fill, and resizing the generated content fill in accordance with one or more embodiments;

FIGS. 7A-7C illustrate the intelligent bounds content generation system intelligently resizing a fill region bounding box for a digital image in accordance with one or more embodiments;

FIG. 8 illustrates an example schematic diagram of an intelligent bounds content generation system in accordance with one or more embodiments;

FIG. 9 illustrates a flowchart of a series of acts for intelligently resizing a fill region bounding box and utilizing the resized bounding box to generate a modified image with generated content in accordance with one or more embodiments; and

FIG. 10 illustrates a block diagram of an exemplary computing device in accordance with one or more embodiments.

### DETAILED DESCRIPTION

One or more embodiments described herein include the intelligent bounds content generation system that by generates content for a digital image utilizing deep learning and source inputs with intelligent bounds. For example, in one or more embodiments, the intelligent bounds content generation system intelligently derives, from an indicated fill region, a source image bounds (e.g., a boundary) that will result in high quality generated content when provided as an input to a diffusion generative model. For example, the intelligent bounds content generation system modifies the bounds of the indicated fill region to have a size that provides sufficient context to the generative model for content generation while not providing too much context (too large a source image bounds) that will result in generated content with a degraded resolution. In another example, the intelligent bounds content generation system modifies a size or shape of the source image bounds so that it meets an input requirement of the generative model. Specifically, the intelligent bounds content generation system modifies the source image bounds to have dimensions required by the generative model. In still further implementations, the intelligent bounds content generation system modifies a size of the source image bounds to help ensure that the generated content will have high-quality resolution and sharpness. Thus, the intelligent bounds content generation system utilizes source image bounds with intelligently modified bounds to generate content utilizing a generative model.

More specifically, the intelligent bounds content generation system receives or identifies a fill region and a text prompt identifying content to generate in the fill region. The intelligent bounds content generation system identifies required input dimensions for a generative model. The intelligent bounds content generation system automatically (e.g., without further user input) generates intelligently-sized source image bounds from the fill region to the dimensions required by the generative model. The intelligent bounds content generation system generates content (e.g., a content fill) corresponding to the text prompt utilizing the generative model from the intelligently-sized source image bounds. The intelligent bounds content generation system automatically inversely scales the content fill to the size of the original fill region and combines it with the digital image to form a modified image.

More specifically, the intelligent bounds content generation system determines source image bounds about a fill region by adding a margin about the fill region. The intelligent bounds content generation system expands the fill region bounds by adding the margin to provide sufficient context for the generative model to generate a high-quality content fill. Furthermore, the intelligent bounds content generation system intelligently selects the size of the source image bounds to provide sufficient context without expanding the source image bounds to the point at which the generative model will generate a degraded content fill (i.e., low resolution output).

The intelligent bounds content generation system provides advantages over conventional systems. Indeed, conventional systems often suffer from several technological shortcomings that result in inefficient, inflexible, and inaccurate operation. For example, some conventional systems provide the only fill region to the generative model. By so doing, such conventional systems often generate content that does not sufficiently correspond with the overall content of the digital image. Indeed, image results generated by such systems are often poor in quality, having an unnatural appearance. Furthermore, such conventional systems are often inflexible in that the size of the digital image needs to correspond with a required input size of the conventional generative system. Often such required input sizes are relatively small resulting in a low resolution output.

Additionally, conventional systems often provide the entire input digital image as input to a generative model. Such practice, however, leads to generated content with low resolution and sharpness, particularly when the fill region is relatively small compared to the size of the digital image. Indeed, conventional systems often produce generated content with limited resolution-typically well below the resolution of the rest of the digital image. Additionally, by processing an entire image, such models typically require a significant amount of memory to operate, and the required amount often scales with the resolution of the image being processed. Thus, these systems are often computationally demanding when generating digital content.

One or more embodiments of the intelligent bounds content generation system operates with improved flexibility when compared to conventional systems. For example, by intelligently scaling inputs and outputs of a generative model, the intelligent bounds content generation system flexibly generates content for digital images independent of the resolution of the image. Specifically, the intelligent bounds content generation system scales the source image bounds of a fill region to fit the requirements of the generative model and rescales the output of the generative model to the original image size.

Furthermore, the intelligent bounds content generation system operates flexibly by allowing for fill regions of arbitrary shape and size. In contrast to some conventional systems that require a fill region provided by a user to have a predetermined shape or size, the intelligent bounds content generation system intelligently adds margins, modifies aspect ratio, and scales fill regions, thereby allowing for fill region of arbitrary size and shape. By so doing, the intelligent bounds content generation system flexibly allows a user to select, draw, or otherwise provide a fill region of any desired size or shape.

Further, one or more embodiments of the intelligent bounds content generation system operates with improved accuracy when compared to conventional systems. For example, by intelligently resizing source image boundaries, the intelligent bounds content generation system provides a margin about the fill region to provide sufficient context to the generative model. In this manner the intelligent bounds content generation system generates content that is harmonized well with the surrounding pre-existing content of the digital image. Thus, the intelligent bounds content generation system produces digital images with generated content that are high in quality and have a natural appearance.

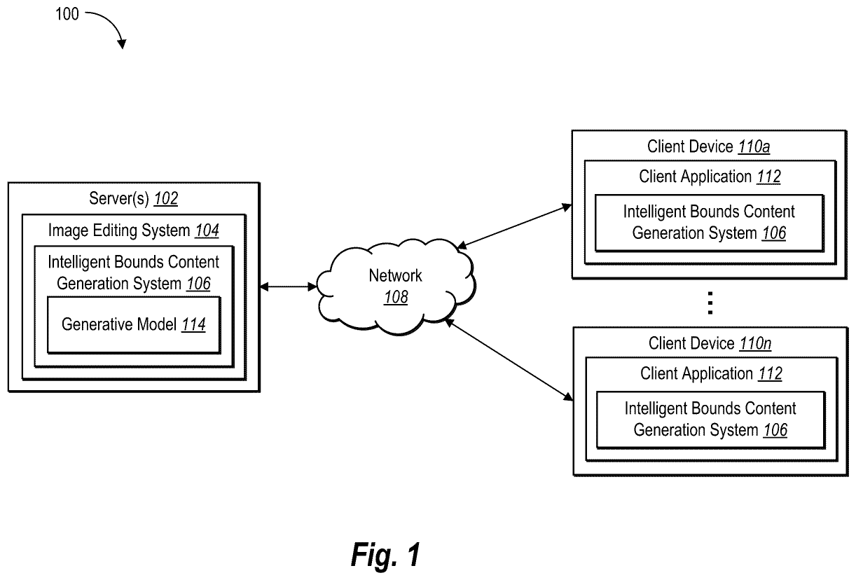

Additional detail regarding the intelligent bounds content generation system will now be provided with reference to the figures. For example, FIG. 1 illustrates a schematic diagram of an exemplary system 100 in which the intelligent bounds content generation system 106 operates. As illustrated in FIG. 1, the system 100 includes a server(s) 102, a network 108, and client devices 110a-110n.

Although the system 100 of FIG. 1 is depicted as having a particular number of components, the system 100 is capable of having any number of additional or alternative components (e.g., any number of servers, client devices, or other components in communication with the intelligent bounds content generation system 106 via the network 108). Similarly, although FIG. 1 illustrates a particular arrangement of the server(s) 102, the network 108, and the client devices 110a-110n, various additional arrangements are possible.

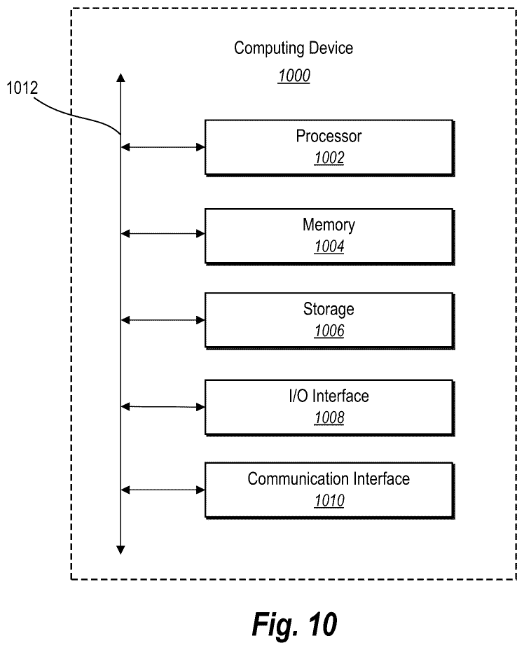

The server(s) 102, the network 108, and the client devices 110a-110n are communicatively coupled with each other either directly or indirectly (e.g., through the network 108 discussed in greater detail below in relation to FIG. 10). Moreover, the server(s) 102 and the client devices 110a-110n include one or more of a variety of computing devices (including one or more computing devices as discussed in greater detail with relation to FIG. 10).

As mentioned above, the system 100 includes the server(s) 102. In one or more embodiments, the server(s) 102 generates, stores, receives, and/or transmits data, including digital images, generated content portions, and/or modified digital images having the generated content portions. In one or more embodiments, the server(s) 102 comprises a data server. In some implementations, the server(s) 102 comprises a communication server or a web-hosting server.

In one or more embodiments, the image editing system 104 provides functionality by which a client device (e.g., a user of one of the client devices 110a-110n) generates, edits, manages, and/or stores digital images. For example, in some instances, a client device sends a digital image to the image editing system 104 hosted on the server(s) 102 via the network 108. The image editing system 104 then provides many options that are usable by the client device to edit the digital image, store the digital image, and subsequently search for, access, and view the digital image. For instance, in some cases, the image editing system 104 provides one or more options that are usable by the client device to modify a digital image with a generated content portion.

In one or more embodiments, the client devices 110a-110n include computing devices that are capable of accessing, modifying, and/or storing digital images, including modified digital images and/or modified digital images. For example, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that are capable of accessing, modifying, and/or storing digital images, including modified digital images and/or modified digital images. For example, in one or more embodiments, the client application 112 includes a software application installed on the client devices 110a-110n. Additionally, or alternatively, the client application 112 includes a web browser or other application that accesses a software application hosted on the server(s) 102 (and supported by the image editing system 104).

To provide an example implementation, in some embodiments, the intelligent bounds content generation system 106 on the server(s) 102 supports the intelligent bounds content generation system 106 on the client device 110n. For instance, in some cases, the intelligent bounds content generation system 106 on the server(s) 102 generates or learns parameters for the generative model 114. The intelligent bounds content generation system 106 then, via the server(s) 102, provides the generative model 114 to the client device 110n. In other words, the client device 110n obtains (e.g., downloads) the generative model 114 (e.g., with any learned parameters) from the server(s) 102. Once downloaded, the intelligent bounds content generation system 106 on the client device 110n utilizes the generative model 114 to generate content for digital image independent from the server(s) 102.

In alternative implementations, the intelligent bounds content generation system 106 includes a web hosting application that allows the client device 110n to interact with content and services hosted on the server(s) 102. To illustrate, in one or more implementations, the client device 110n accesses a software application supported by the server(s) 102. The client device 110n provides input to the server(s) 102, such as a digital image having pixels to be replaced with a generated content portion. In response, the intelligent bounds content generation system 106 on the server(s) 102 generates a modified digital image with a generated content portion based on an intelligently resized fill region. The server(s) 102 then provides the modified digital image to the client device 110n for display.

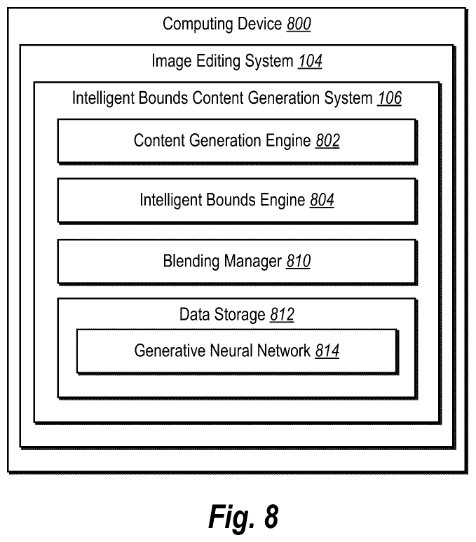

Indeed, the intelligent bounds content generation system 106 is able to be implemented in whole, or in part, by the individual elements of the system 100. Indeed, although FIG. 1 illustrates the intelligent bounds content generation system 106 implemented with regard to the server(s) 102, different components of the intelligent bounds content generation system 106 are able to be implemented by a variety of devices within the system 100. For example, one or more (or all) components of the intelligent bounds content generation system 106 are implemented by a different computing device (e.g., one of the client devices 110a-110n) or a separate server from the server(s) 102 hosting the image editing system 104. Indeed, as shown in FIG. 1, the client devices 110a-110n include the intelligent bounds content generation system 106. Example components of the intelligent bounds content generation system 106 will be described below with regard to FIG. 8.

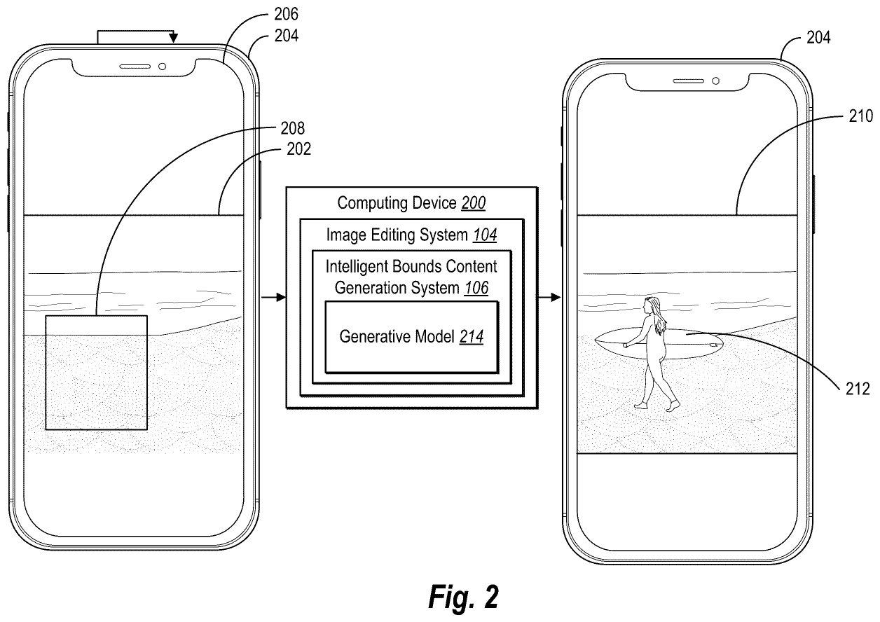

As mentioned, in one or more embodiments, the intelligent bounds content generation system 106 generates a modified digital image with generated content from a digital image. In particular, the intelligent bounds content generation system 106 generates a modified digital image having a generated content portion that replaces a set of pixels within the digital image. FIG. 2 illustrates the intelligent bounds content generation system 106 generating a modified digital image in accordance with one or more embodiments.

In one or more embodiments, a generated content portion includes digital content that has been generated for inclusion within a digital image. For instance, in some embodiments, a generated content portion includes digital content that was not initially part of a digital image (e.g., not included within the digital image when the digital image was initially captured or created) but has been subsequently generated for inclusion within the digital image. To illustrate, in some instances, a generated content portion includes an object, a portion of an object, a scenery, or a portion of scenery generated for inclusion within a digital image. In some implementations, a generated content portion includes digital content generated by an artificial intelligence (AI) based model (e.g., a generative model), as will be discussed more below. Further, in some cases, a generated content portion includes digital content generated to replace a set of pixels within a digital image. In some instances, however, a generated content portion includes digital content that adds to the digital image beyond the initial boundaries of the digital image (e.g., outpainting rather than inpainting).

As shown in FIG. 2, the intelligent bounds content generation system 106 (operating on a computing device 200) receives a digital image 202 from a client device 204. In some cases, the intelligent bounds content generation system 106 further receives, via a graphical user interface 206 of the client device 204, user input for modifying the digital image 202. For example, in some instances, the intelligent bounds content generation system 106 receives an indication of a fill region 208 for generating content within the digital image 202. In some cases, in addition to receiving the user input indicating the fill region 208, the intelligent bounds content generation system 106 receives an indication of the content to generate in the fill region 208. For example, the intelligent bounds content generation system 106 receives a text prompt to generate a woman with a surfboard in the fill region 208.

As further shown in FIG. 2, the intelligent bounds content generation system 106 generates a modified digital image 210 from the digital image 202. As illustrated, the modified digital image 210 is modified relative to the digital image 202. Specifically, the intelligent bounds content generation system 106 intelligently derives source image bounds from the fill region 208 as described herein and generated content 212 (e.g., the woman with the surfboard) to replace pixels originally in the fill region 208. Specifically, the intelligent bounds content generation system 106 utilizes the generative model 214 to generate the content 212 for the modified digital image 210.

As illustrated, the intelligent bounds content generation system 106 uses a generative model 214 to generate the content 212. In one or more embodiments, a generative model is a machine learning model that generates new content that resembles training data used to train the generative model. A machine learning model includes a computer representation that is tunable (e.g., trained) based on inputs to approximate unknown functions used for generating the corresponding outputs. In particular, in some embodiments, a machine learning model includes a computer-implemented model that utilizes algorithms to learn from, and make predictions on, known data by analyzing the known data to learn to generate outputs that reflect patterns and attributes of the known data. For instance, in some instances, a machine learning model includes, but is not limited to a neural network (e.g., a convolutional neural network, recurrent neural network or other deep learning network), a decision tree (e.g., a gradient boosted decision tree), association rule learning, inductive logic programming, support vector learning, Bayesian network, regression-based model (e.g., censored regression), principal component analysis, or a combination thereof.

In some embodiments, the generative model is a neural network. A neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, a transformer, or a diffusion neural network. In some embodiments, a neural network includes a combination of neural networks or neural network components. In one or more embodiments, the generative model 214 comprises a generative adversarial neural network, a variational autoencoder, an autoregressive model, or a diffusion neural network.

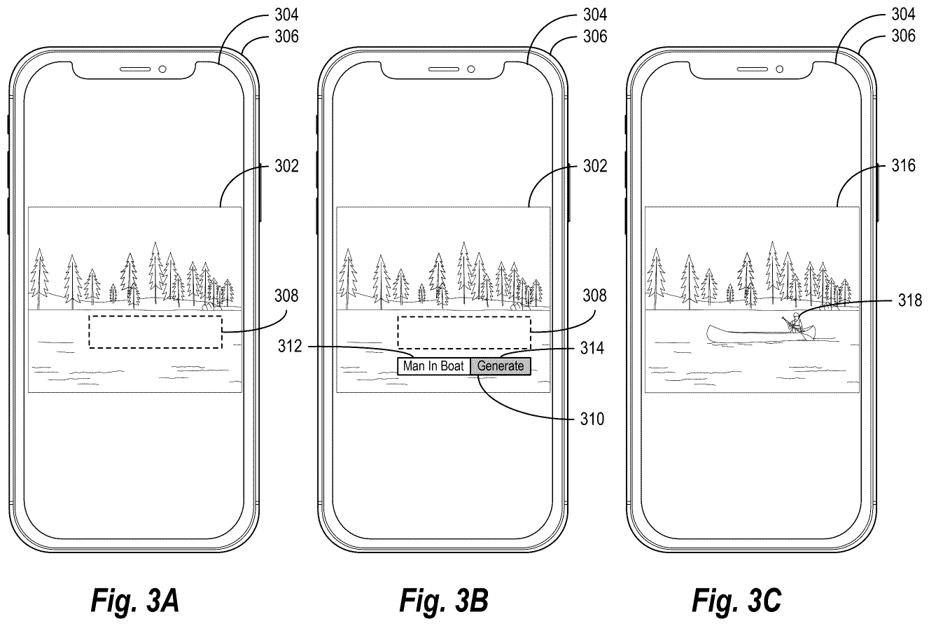

As just mentioned, in one or more embodiments, the intelligent bounds content generation system 106 intelligently resizes a fill region while generating content to fill the fill region. FIGS. 3A-3C illustrate the intelligent bounds content generation system 106 generating a modified digital image having a generated content portion in accordance with one or more embodiments. In particular, FIGS. 3A-3C illustrate the intelligent bounds content generation system 106 generating a modified digital image having a generated content portion in response to user input received from a client device in accordance with one or more embodiments.

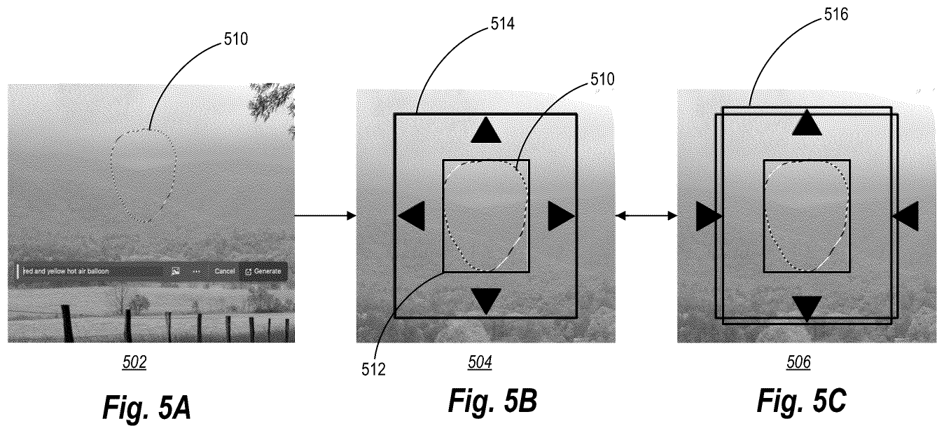

Indeed, as shown in FIG. 3A, the intelligent bounds content generation system 106 provides a digital image 302 for display within a graphical user interface 304 of a client device 306. The user generates a fill region 308 via one or more tools provided by the intelligent bounds content generation system 106 via the graphical user interface 304. For example, as shown in FIG. 3A a user generates the fill region 308 as a bounding box. Alternatively, the user can use a pencil or other free hand tool to draw the fill region 308. In any event, the intelligent bounds content generation system 106 intelligently derives source image bounds from the fill region 308 as explained in greater detail below with reference to FIGS. 5-7C.

In one or more embodiments, the intelligent bounds content generation system 106 generates and provides the fill region 308 for display in response to one or more user interactions with the digital image 302 via the graphical user interface 304. For instance, in some cases, the intelligent bounds content generation system 106 generates and provides the fill region 308 in response to one or more user interactions outlining or otherwise designating the portion of the digital image 302 to be modified. Upon providing the fill region 308, a user can resize, modify the shape, or reposition the fill region 308 as desired.

As shown in FIG. 3B, the intelligent bounds content generation system 106 provides an interactive element 310 for display within the graphical user interface 304. In some cases, the intelligent bounds content generation system 106 provides the interactive element 310 for display in response to the user input designating the portion of the digital image 302 to be modified. Thus, in some instances, the intelligent bounds content generation system 106 provides the interactive element 310 in association with the fill region 308.

As illustrated, the interactive element 310 includes a text box 312 for user input. Indeed, as indicated, the intelligent bounds content generation system 106 receives text input via the text box 312. In certain embodiments, the text input indicates a modification to be made to the portion of the digital image 302 indicated by the fill region 308. For instance, as shown, the text input indicates a generated content portion (e.g., an object) to be added to the portion of the digital image 302.

The interactive element 310 also includes a selectable option 314 for modifying the digital image 302 in accordance with the text input received via the text box 312. For instance, as illustrated, the selectable option 314 includes a button for generating the generated content portion indicated by the received text input. Thus, in some cases, the intelligent bounds content generation system 106 generates a generated content portion for inclusion within the digital image 302 in response to detecting a selection of the selectable option 314. In particular, the intelligent bounds content generation system 106 generates a modified digital image having the generated content portion.

Indeed, as illustrated in FIG. 3C, the intelligent bounds content generation system 106 provides a modified digital image 316 for display within the graphical user interface 304 of the client device 306. As shown, the modified digital image 316 corresponds to the digital image 302 in that the modified digital image 316 portrays the same scene portrayed within the digital image 302. In other words, the modified digital image 316 is a modified version of the digital image 302. Indeed, while the present disclosure separately refers to a digital image and a modified digital image, it should be noted that a modified digital image includes a modified version of a digital image. In particular, in one or more embodiments, a modified digital image includes a digital image having one or more modifications applied thereto (e.g., a set of pixels replaced with a generated content portion or having one or more borders extended with the addition of a generated content portion). While, in some instances, a modified digital image includes a separate image file from the digital image used to generate the modified digital image, the modified digital image includes the same image file but modified based on changes to the digital image in other cases.

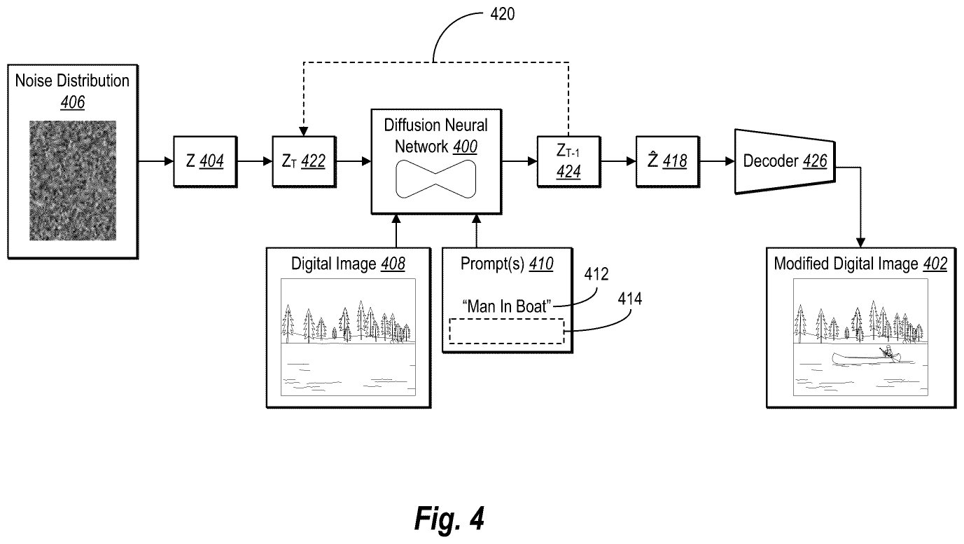

Indeed, as further shown, the modified digital image 316 includes a generated content portion 318 added to the portion of the digital image 302 indicated by the fill region 308. Thus, in certain embodiments, the intelligent bounds content generation system 106 generates the modified digital image 316 from the digital image 302 by generating the generated content portion 318 and incorporating the generated content portion 318 within the digital image 302. In some implementations, the intelligent bounds content generation system 106 generates the modified digital image 316 as described below with reference to FIG. 4.

Thus, in one or more embodiments, the intelligent bounds content generation system 106 modifies a digital image by replacing a set of pixels within the digital image with a generated content portion. To illustrate, in some cases, the intelligent bounds content generation system 106 receives user input identifying a set of pixels within a digital image (e.g., an object or a portion of the background) to be replaced with a generated content portion. In response to the user input, the intelligent bounds content generation system 106 generates the generated content portion. The intelligent bounds content generation system 106 further replaces the identified set of pixels with the generated content portion, such as by removing the set of pixels and filling in the resulting hole with the generated content portion (e.g., via inpainting) or by superimposing the generated content portion over the set of pixels.

Additionally, while the present disclosure largely discusses modifying a digital image by replacing pixels portrayed therein, the intelligent bounds content generation system 106 modifies a digital image by extending the digital image beyond its initial boundaries (e.g., via outpainting) in some cases. Indeed, in some implementations, the intelligent bounds content generation system 106 uses a generated content portion to add to the height and/or width of a digital image. Thus, in certain embodiments, rather than replacing pixels of a digital image with a generated content portion, the intelligent bounds content generation system 106 uses a generated content portion to portray portions of the scene of a digital image that were outside the boundaries when the digital image was initially captured or created (e.g., outside the boundaries of the camera used to capture the digital image or outside the boundaries of the canvas used to create the digital image).

As previously discussed, in one or more embodiments, the intelligent bounds content generation system 106 modifies a digital image by replacing a set of pixels portrayed therein with a generated content portion (or by extending the height and/or width of the digital image). In other words, the intelligent bounds content generation system 106 generates a modified digital image having the generated content portion in place of the set of pixels (or added to one or more ends of the digital image). As further discussed, in some implementations, the intelligent bounds content generation system 106 generates the modified digital image (e.g., generates the generated content portion) using a generative model. FIG. 4 illustrates the intelligent bounds content generation system 106 generating a modified digital image having a generated content portion using a generative model in the form a generative neural network in accordance with one or more embodiments.

Indeed, FIG. 4 illustrates the intelligent bounds content generation system 106 using a generative neural network to generate a modified digital image having a generated content portion. In one or more embodiments, a generative neural network includes a computer-implemented neural network that generates digital content. In particular, in some embodiments, a generative neural network includes a neural network that generates digital visual content. For instance, in some cases, a generative neural network includes a neural network that generates generated content portions for inclusion within digital images. In some instances, a generative neural network includes a neural network that generates modified digital images having the generated content portions.

In particular, FIG. 4 illustrates the intelligent bounds content generation system 106 using a diffusion neural network 400 to generate a modified digital image 402 having a generated content portion in accordance with one or more embodiments. As shown in FIG. 4, the intelligent bounds content generation system 106 determines a noised latent tensor 404 (represented as z) from a noise distribution 406. For instance, in some implementations, the intelligent bounds content generation system 106 samples from the noise distribution 406 to determine the noised latent tensor 404. As shown, the intelligent bounds content generation system 106 provides the noised latent tensor 404 as input to the diffusion neural network 400.

As further illustrated, the intelligent bounds content generation system 106 also provides a digital image 408 and one or more prompts 410 as input to the diffusion neural network 400. In one or more embodiments, the digital image 408 includes the digital image to be modified with a generated content portion. Further, in some embodiments, the one or more prompts 410 include at least one of a text prompt 412 or a fill region prompt 414, where the fill region prompt 414 indicates the portion of the digital image 408 to be modified with the generated content portion (e.g., the set of pixels to be replaced with the generated content portion). In certain embodiments, the intelligent bounds content generation system 106 uses the digital image 408 and/or the one or more prompts 410 to as one or more conditions (e.g., a spatial condition and/or a global condition) to for the diffusion neural network 400.

Prior to providing the content fill region prompt 414 as input to the diffusion neural network 400, the intelligent bounds content generation system 106 intelligently derives intelligent source image bounds from the fill region provided as a prompt by the user. The intelligent bounds content generation system 106 intelligently derives from the indicated fill region the source image bounds (e.g., a boundary) that will result in high quality generated content when provided as an input to the diffusion neural network 400. For example, the intelligent bounds content generation system 106 modifies the bounds of the indicated fill region to have a size that provides sufficient context to the diffusion neural network 400 for content generation while not providing too much context (too large a source image bounds) that will result in generated content with a degraded resolution. In other example, the intelligent bounds content generation system 106 modifies a size or shape of the source image bounds so that it meets an input requirement of the diffusion neural network 400. Specifically, the intelligent bounds content generation system 106 modifies the source image bounds to have dimensions required by the diffusion neural network 400. In still further implementations, the intelligent bounds content generation system 106 modifies a size of the source image bounds to help ensure that the generated content will have high-quality resolution and sharpness. Thus, the intelligent bounds content generation system 106 utilizes a fill region with intelligently modified bounds and the digital image to generate content utilizing diffusion neural network 400.

Furthermore, the intelligent bounds content generation system 106, in one or more implementations, provides the fill region with intelligently modified bounds as an input to the diffusion neural network 400 as a fill region mask. In one or more embodiments, a fill region mask includes a map of a digital image that has an indication for each pixel of whether the pixel corresponds to the fill region or not. In some implementations, the indication includes a binary indication (e.g., a “1” for pixels belonging to the fill region and a “0” for pixels not belonging to the fill region).

As illustrated in FIG. 4, the intelligent bounds content generation system 106 uses the diffusion neural network 400 to generate a denoised latent tensor 418 (represented as 2) from the noised latent tensor 404. In particular, in some cases, the intelligent bounds content generation system 106 uses the diffusion neural network 400 to generate the denoised latent tensor 418 from the noised latent tensor 404 based on the one or more conditions represented by the digital image 408 and/or the one or more prompts 410 (e.g., text prompt and the intelligently sized source image bounds in the form of a content fill mask).

As further illustrated, the intelligent bounds content generation system 106 uses the diffusion neural network 400 to generate the denoised latent tensor 418 from the noised latent tensor 404 via an iterative denoising process (indicated by the dashed arrow 420). Indeed, in some embodiments, the intelligent bounds content generation system 106 uses the diffusion neural network 400 to generates the denoised latent tensor 418 over a plurality of diffusion steps. Thus, as shown by FIG. 4, for a given diffusion step, the diffusion neural network 400 processes a first latent tensor 422 (represented as z_{T}) to generate a second latent tensor 424 (represented as z_{T-1}), where the transition from T to T−1 represents a transition as part of a backward diffusion process q(zₜ₋₁|zₜ). In some cases, while the first latent tensor 422 includes a noised latent tensor (as it has not completed the denoising process), the second latent tensor 424 represents a noised latent tensor (e.g., if the denoising process has not finished) or a denoised latent tensor (e.g., if the denoising process is complete). To illustrate, in some instances, for a first diffusion step, the first latent tensor 422 includes the noised latent tensor 404. Additionally, in some cases, for a last diffusion step, the second latent tensor 424 includes the denoised latent tensor 418.

As further shown in FIG. 4, the intelligent bounds content generation system 106 uses a decoder 426 to generate the modified digital image 402 from the denoised latent tensor 418. For instance, in some cases, the latent tensors processed and output by the diffusion neural network 400 include data in latent space. Accordingly, the intelligent bounds content generation system 106 uses the decoder 426 to project the data of the denoised latent tensor 418 into pixel space in some implementations.

In one or more embodiments, the intelligent bounds content generation system 106 uses, as the diffusion neural network 400, the controlled diffusion neural network described in U.S. patent application Ser. No. 18/455,023 filed on Aug. 24, 2023, entitled GENERATING DIGITAL MATERIALS FROM DIGITAL IMAGES USING A CONTROLLED DIFFUSION NEURAL NETWORK, which is incorporated herein by reference in its entirety. In some cases, the intelligent bounds content generation system 106 further uses the decoders, style encoder, and/or conditioning network described in U.S. patent application Ser. No. 18/455,023.

Although FIG. 4 shows the intelligent bounds content generation system 106 using a diffusion neural network to generate a modified digital image having a generated content portion, the intelligent bounds content generation system 106 uses various generative neural networks in various implementations. For instance, in some cases, the intelligent bounds content generation system 106 uses a generative adversarial network to generate a modified digital image having a generated content portion. For example, in some embodiments, the intelligent bounds content generation system 106 uses a cascaded modulation generative adversarial neural network (e.g., the cascaded modulation inpainting neural network) described in U.S. patent application Ser. No. 17/661,985 filed on May 4, 2022, entitled DIGITAL IMAGE INPAINTING UTILIZING A CASCADED MODULATION INPAINTING NEURAL NETWORK or the cascaded modulated generative adversarial network described in U.S. patent application Ser. No. 18/232,212 filed on Aug. 9, 2023, entitled DEEP LEARNING-BASED HIGH RESOLUTION IMAGE INPAINTING, both of which are incorporated herein by reference in their entirety.

Turning now to FIGS. 5A-5C, more details will now be provided regarding the intelligent bounds content generation system 106 intelligently deriving image source boundaries from fill regions in accordance with one or more implementations. FIG. 5A illustrates a graphical user interface 502 via which the intelligent bounds content generation system 106 displays an image. A user selects an option to generate content in the digital image. As shown in FIG. 5A, the user draws a fill region 510 in which the user desires to generate content. The fill region 510 comprises a custom fill region that the user drew by hand. In alternative implementations, the intelligent bounds content generation system 106 provides a tool to aid in generating the fill region. For example, the intelligent bounds content generation system 106 provides a tool that preconfigures the shape of the fill region (e.g., a bounding box creation tool, a circle creation tool, or a tool for creating another shape). Using the tool, a user is able to generate a bounding box or other shape of a desired size.

As shown by FIG. 5A, the intelligent bounds content generation system 106 further provides a text prompt box. The text prompt box allows a user to specify the content to be generated within the fill region 510. As shown in FIG. 5A, the user has added a text prompt of a red and yellow hot air balloon to the text prompt box. In response to the user selecting the generate graphical user interface option, the intelligent bounds content generation system 106 intelligently derives source image bounds from the fill region and utilizes the bounded source image to generate content for the fill region.

For example, FIG. 5B visually illustrates how the intelligent bounds content generation system 106 derives source image bounds from the fill region 510 provided by the user. Specifically, when the fill region 510 comprises a custom shape as shown in FIG. 5B, the intelligent bounds content generation system 106 generates a bounding box 512 to fit about the fill region 510. In alternative implementations, the user provides a fill region that is a bounding box. In such implementations, the intelligent bounds content generation system 106 uses the bounding box provided by the user and does not generate a bounding box.

As shown in FIG. 5B, the intelligent bounds content generation system 106 provides a margin about the bounding box 512. In other words, the intelligent bounds content generation system 106 generates expanded source image bounds 514 by inflating the bounding box 512 with a uniform margin. The intelligent bounds content generation system 106 generates the expanded source image bounds 514 to ensure that the generative model has enough context to generate content for the fill region that is well harmonized to the surrounding content of the digital image.

In one or more implementations, the intelligent bounds content generation system 106 provides a uniformly sized margin about the bounding box 512 by expanding the bounding box 512 by a predetermined scalar. For example, in one or more implementations, the intelligent bounds content generation system 106 generates the expanded source image bounds by increasing the area of the bounding box 512 by a factor of 1.5, 2, 2.5, 3, 3.5, or 4.

Thus, in one or more implementations, the intelligent bounds content generation system 106 expands the bounding box 512 by adding a margin to provide sufficient context for the generative model to generate a high quality content fill. Furthermore, the intelligent bounds content generation system 106 intelligently selects the size of the expanded source image bounds 514 to provide sufficient context without expanding the fill region to the point at which the generative model will generate a degraded content fill (i.e., low resolution output).

As illustrated by FIG. 5C the intelligent bounds content generation system 106 conforms the expanded source image bounds 514 to an aspect ratio supported by the generative model. For example, the intelligent bounds content generation system 106 resizes the expanded source image bounds 514 to generate an aspect conforming source image bounds 516. In other words, the intelligent bounds content generation system 106 modifies an aspect ratio of the expanded source image bounds 514 to generate the aspect conforming source image bounds 516. For example, in one or more implementations, the intelligent bounds content generation system 106 maintains an area of the expanded source image bounds 514. Specifically, as shown in FIG. 5C, the intelligent bounds content generation system 106 adjusts both a width and a height of the expanded source image bounds 514 to generate the aspect conforming source image bounds 516. For instance, the intelligent bounds content generation system 106 increases a height of the expanded source image bounds 514 and decreases a width of the expanded source image bounds 514 to generate the aspect conforming source image bounds 516. In this manner, the intelligent bounds content generation system 106 generates an aspect conforming source image bounds 516 that has the same area as the expanded source image bounds 514. By maintaining the area of the expanded source image bounds 514, the intelligent bounds content generation system 106 ensures that there is sufficient context for the generative model.

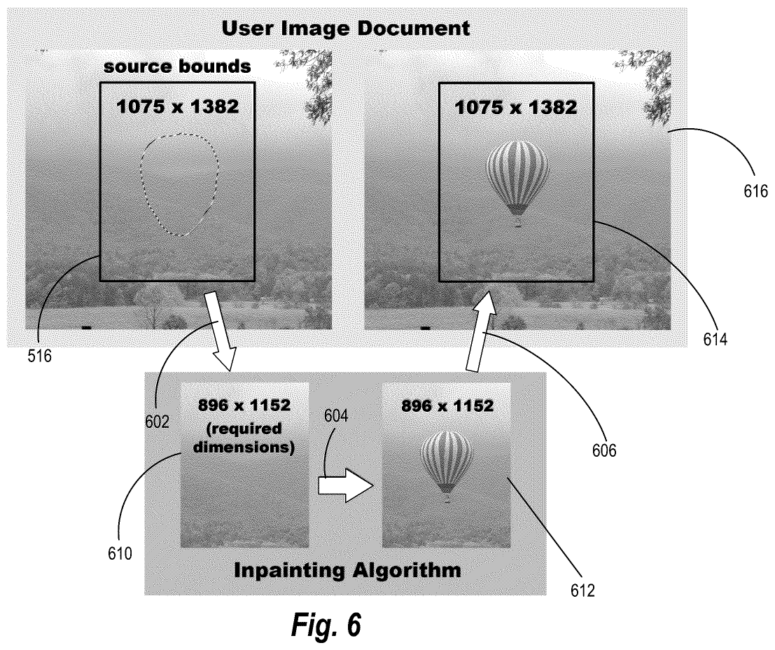

Conforming the source image bounds to an aspect ratio supported by the generative model allows for later uniform scaling of inputs and outputs of the generative model. The ability to proportionally scale the input and outputs to the generative model promotes proper shape and proportions of content generated by the generative model. For example, in the use case shown in FIGS. 5A-6, the rounded edges of the generated hot air balloon remain rounded in the output of the generative model and the final modified image, as will be described below.

In the illustrated implementation of FIG. 6, the intelligent bounds content generation system 106 generates an aspect conforming source image bounds 516 having a size of 1075×1382 with an aspect ratio conforming to an aspect ratio supported by the generative model. One will appreciate that the size of 1075×1382 is an example for illustrative purposes and is not limiting. In alternative implementations, the intelligent bounds content generation system 106 generates conforming source image bounds of a different size.

As shown by FIG. 6, the intelligent bounds content generation system 106 performs an act 602 of scaling the aspect conforming source image and corresponding fill region 510 to a size supported by the generative model. In other words, the intelligent bounds content generation system 106 generates a conforming source image and the fill region mask by scaling the aspect conforming source image bounds 516 by a scaling factor. In the illustrated implementation, the intelligent bounds content generation system 106 generates a conforming input image and fill region mask of a size of 896×1152. In alternative implementations, the size supported by the generative model is larger or smaller than the illustrated size. In one or more implementations, the generative model supports a range of sizes.

The intelligent bounds content generation system 106 performs an act 604 of generating a content fill 612 from the conforming input image and fill region mask utilizing the generative model. For example, the intelligent bounds content generation system 106 utilizes a diffusion neural network as described above in relation to FIG. 4. As shown in FIG. 6, the generated content fill 612 has a size matching the size of the conforming source image bounds 610.

The intelligent bounds content generation system 106 generates a modified digital image 616 comprising the generated content fill 612. Specifically, the intelligent bounds content generation system 106 inversely scales the generated content fill 612 to the size of the aspect conforming source image bounds 516 to generate a scaled content fill 614. For example, the intelligent bounds content generation system 106 inversely scales the generated content fill 612 by the same scaling factor used to scale the aspect conforming source image bounds 516 to generate the conforming source image bounds 610. The intelligent bounds content generation system 106 generates the modified digital image 616 by compositing the scaled content fill 614 and the digital image. In one or more implementations, the intelligent bounds content generation system 106 further performs one or more blending operations to ensure that the scaled content fill 614 is harmonized with the bordering content of the digital image.

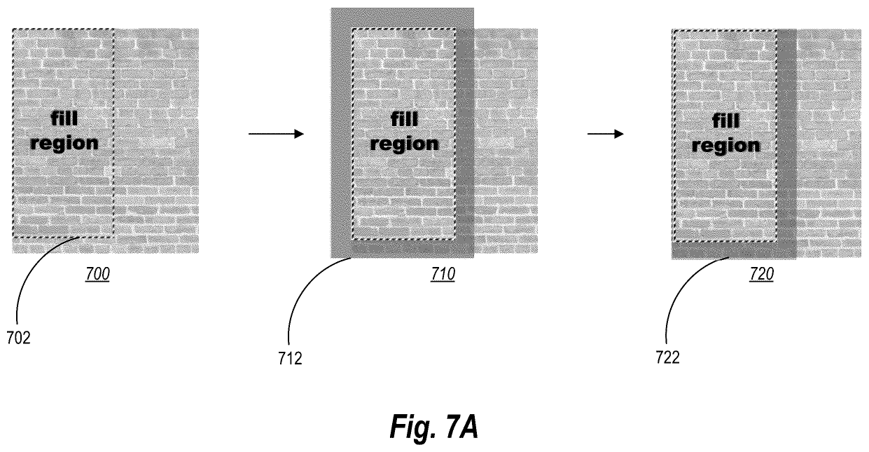

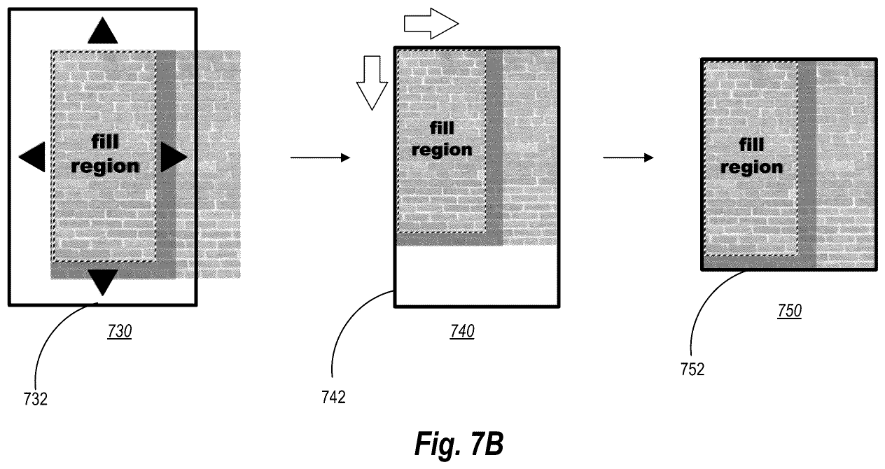

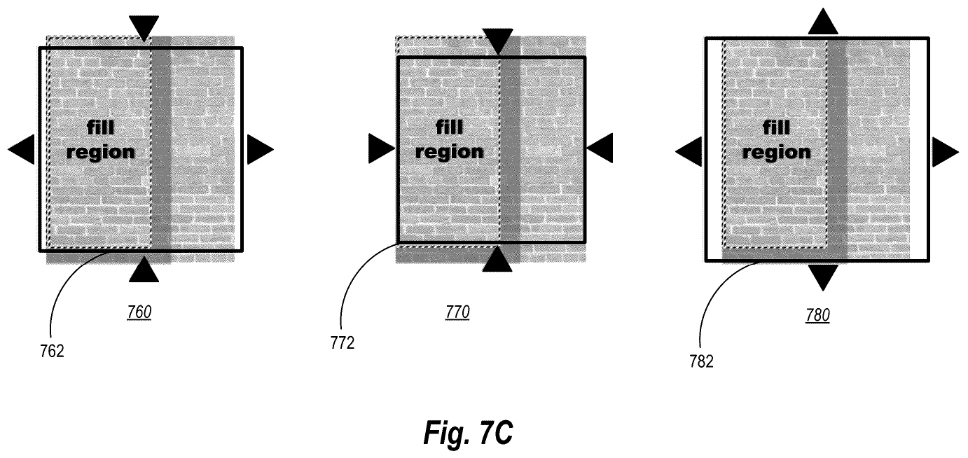

FIGS. 7A-7C illustrate another implementation of intelligently deriving source image bounds from a fill region. Specifically, FIGS. 7A-7C provide acts of an algorithm for intelligently deriving source image bounds from a fill region. For example, FIG. 7A illustrates the intelligent bounds content generation system 106 performing an act 700 of identifying a fill region 702. Specifically, the intelligent bounds content generation system 106 identifies a fill region 702 generated by user input as described above. In act 710 the intelligent bounds content generation system 106 generates a minimum margin 712 about the fill region 702. The intelligent bounds content generation system 106 generates the minimum margin 712 to safeguard against reducing the margin to zero in other acts of the algorithm.

FIG. 7A further illustrates the intelligent bounds content generation system 106 performing an act 720 of clipping the minimum margin 712 to generate a clipped minimum margin 722. Specifically, the intelligent bounds content generation system 106 clips portions of the minimum margin 712 that extend beyond the bounds of the digital image. The intelligent bounds content generation system 106 clips the portions of the minimum margin 712 as no margin is needed over areas without image content.

FIG. 7B illustrates the intelligent bounds content generation system 106 performing an act 730 of generating an expanded source image bounds 732. For example, as described above, the intelligent bounds content generation system 106 generates the expanded source image bounds 732 by expanding the fill region 702 by a pre-determined factor (e.g., 2 times or 3 times the area). Thus, the intelligent bounds content generation system 106 generates an expanded source image bounds 732 that has an area that is a factor larger than the fill region 702 specified by the user.

As illustrated by FIG. 7B, the intelligent bounds content generation system 106 performs an act 740 of offsetting the expanded source image bounds 732. For example, the intelligent bounds content generation system 106 generates an offset expanded source image bounds 742 to increase or maximize an overlap between the expanded source image bounds 732 and the digital image. One will appreciate that in some implementations the expanded source image bounds 732 will be entirely over the digital image and the intelligent bounds content generation system 106 will not perform act 740. In still further implementations, the use may specify that the source image bounds extends beyond a boundary of the digital image to perform out-painting. In such implementations, the intelligent bounds content generation system 106 need not perform act 740.

The intelligent bounds content generation system 106 further performs an act 750 of clipping the offset expanded source image bounds 742 as shown by FIG. 7B. For instance, the intelligent bounds content generation system 106 clips portions of the offset expanded source image bounds 742 that extend beyond the digital image to generate a clipped expanded source image bounds 752.

As shown in FIG. 7C, the intelligent bounds content generation system 106 performs an act 760 of generating an aspect conforming source image bounds 762. Specifically, the intelligent bounds content generation system 106 conforms the clipped expanded source image bounds 752 to an aspect ratio supported by the generative model. For example, the intelligent bounds content generation system 106 resizes the clipped expanded source image bounds 752 to generate an aspect conforming source image bounds 762. In other words, the intelligent bounds content generation system 106 modifies an aspect ratio of the clipped expanded source image bounds 752 to generate the aspect conforming source image bounds 762. For example, in one or more implementations, the intelligent bounds content generation system 106 maintains an area of the clipped expanded source image bounds 752. Specifically, as shown in FIG. 7C, the intelligent bounds content generation system 106 adjusts both a width and a height of the clipped expanded source image bounds 752 to generate the aspect conforming source image bounds 762. For instance, the intelligent bounds content generation system 106 decreases a height of the clipped expanded source image bounds 752 and increases a width of the clipped expanded source image bounds 752 to generate the aspect conforming source image bounds 762. In this manner, the intelligent bounds content generation system 106 generates an aspect conforming source image bounds 762 that has the same area as the clipped expanded source image bounds 752. By maintaining the area of the clipped expanded source image bounds 752, the intelligent bounds content generation system 106 ensures that there is sufficient context for the generative model. In the implementation of FIG. 7C, the aspect ratio is a square. In alternative implementations, the aspect ratio supported by the generative model dictates another shape (e.g., a rectangle).

The intelligent bounds content generation system 106 further performs an act 770 of fitting the aspect conforming source image bounds 762 to an upper limit as shown by FIG. 7C. For instance, the intelligent bounds content generation system 106 sets the visible bounds of the digital image as the upper limit for the source image bounds. As part of act 770, the intelligent bounds content generation system 106 scales the aspect conforming source image bounds 762 to fit within the upper limit while maintaining the aspect ratio to generate an upper-clipped aspect conforming source image bounds 772. In the illustrated implementation the intelligent bounds content generation system 106 scales down the aspect conforming source image bounds 762 to fit within the upper limit. In implementations involving outpainting, the intelligent bounds content generation system 106 sets the upper limit bounds as a union of the fill region bounds and the digital image bounds.

The intelligent bounds content generation system 106 further performs an act 780 of fitting upper-clipped aspect conforming source image bounds 772 to cover a lower limit as shown by FIG. 7C. For instance, the intelligent bounds content generation system 106 sets the source image bounds plus the minimum margin as the lower bounds. As part of act 780, the intelligent bounds content generation system 106 scales the upper-clipped aspect conforming source image bounds 772 to cover the lower limit while maintaining the aspect ratio to generate a lower-limit covering aspect conforming source image bounds 782. In the illustrated implementation the intelligent bounds content generation system 106 scales up the upper-clipped aspect conforming source image bounds 772 to cover within the lower limit. In one or more implementations, the final source image bounds of the lower-limit covering aspect conforming source image bounds 782 extend beyond the visible image. One approach to handling this overhang is to add the overhang to the fill region mask. This directs the generative model to fill the overhang. This added fill area is excluded by the intelligent bounds content generation system 106 from the final result when merging the result back to the user's original image. In any event, the intelligent bounds content generation system 106 resizes the lower-limit covering aspect conforming source image bounds 782 to generate conforming source image bounds with a size that meets the requirements of the generative model as described above in relation to FIG. 6.

Turning now to FIG. 8, additional detail will now be provided regarding various components and capabilities of the intelligent bounds content generation system 106. In particular, FIG. 8 illustrates the intelligent bounds content generation system 106 implemented by the computing device 800 (e.g., the server(s) 102 and/or one of the client devices 110a-110n discussed above with reference to FIG. 1). Additionally, the intelligent bounds content generation system 106 is also part of the image editing system 104. As shown, in one or more embodiments, the intelligent bounds content generation system 106 includes, but is not limited to, a content generation engine 802, an intelligent bounds engine 804, a blending manager 810, and data storage 812 (which includes a generative neural network 814 or another generative model).

As just mentioned, and as illustrated in FIG. 8, the intelligent bounds content generation system 106 includes the content generation engine 802. In one or more embodiments, the content generation engine 802 generates generated content portions for inclusion within a digital image. In particular, in some cases, the content generation engine 802 generates, from a digital image, a modified digital image having a generated content portion that replaces a set of pixels from the digital image. In some embodiments, the content generation engine 802 uses an AI-based model, such as a generative neural network 814, to generate the modified digital image.

Additionally, as shown in FIG. 8, the intelligent bounds content generation system 106 includes the intelligent bounds engine 804. In one or more embodiments, the intelligent bounds engine 804 derives source image bounds from a fill region as described herein above to help ensure that the content generated by the generative neural network 814 via the content generation engine 802 is high quality.

As further shown in FIG. 8, the intelligent bounds content generation system 106 includes the blending manager 810. In one or more embodiments, the blending manager 810 blends output (generated content) of the generative neural network 814 with remaining portions of a digital image. As shown in FIG. 8, the intelligent bounds content generation system 106 further includes data storage 812. In particular, data storage 812 includes the generative neural network 814.

Each of the components 802-814 of the intelligent bounds content generation system 106 optionally include software, hardware, or both. For example, in some cases, the components 802-814 include one or more instructions stored on a computer-readable storage medium and executable by processors of one or more computing devices, such as a client device or server device. When executed by the one or more processors, the computer-executable instructions of the intelligent bounds content generation system 106 cause the computing device(s) to perform the methods described herein. Alternatively, in some embodiments, the components 802-814 include hardware, such as a special-purpose processing device to perform a certain function or group of functions. Alternatively, in certain implementations, the components 802-814 of the intelligent bounds content generation system 106 include a combination of computer-executable instructions and hardware.

Furthermore, in one or more embodiments, the components 802-814 of the intelligent bounds content generation system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 802-814 of the intelligent bounds content generation system 106 are implemented as a stand-alone application, such as a desktop or mobile application. Furthermore, in some cases, the components 802-814 of the intelligent bounds content generation system 106 are implemented as one or more web-based applications hosted on a remote server. Alternatively, or additionally, the components 802-814 of the intelligent bounds content generation system 106 are implemented in a suite of mobile device applications or “apps.” For example, in one or more embodiments, the intelligent bounds content generation system 106 comprises or operates in connection with digital software applications such as ADOBE® PHOTOSHOP® or ADOBE® LIGHTROOM®. The foregoing are either registered trademarks or trademarks of Adobe Inc. in the United States and/or other countries.

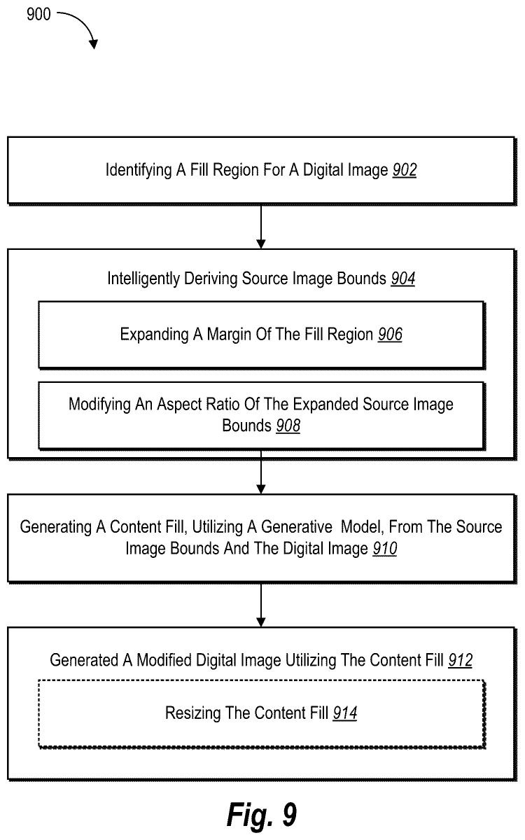

FIGS. 1-8, the corresponding text, and the examples provide a number of different methods, systems, devices, and non-transitory computer-readable media of the intelligent bounds content generation system 106. In addition to the foregoing, one or more embodiments can also be described in terms of flowcharts comprising acts for accomplishing the particular result, as shown in FIG. 9. In certain embodiments, process illustrated in FIG. 9 is performed with more or fewer acts. Further, in some implementations, the acts are performed in different orders. Additionally, in some instances, the acts described herein are repeated or performed in parallel with one another or in parallel with different instances of the same or similar acts.

FIG. 9 illustrates a flowchart of a series of acts 900 for generating a modified digital image with generated content in accordance with one or more embodiments. While FIG. 9 illustrates acts according to one or more embodiments, certain embodiments omit, add to, reorder, and/or modify any of the acts shown in FIG. 9. In some implementations, the acts of FIG. 9 are performed as part of a computer-implemented method. Alternatively, a non-transitory computer-readable medium stores executable instructions thereon that, when executed by at least one processor, cause the at least one processor to perform operations comprising the acts of FIG. 9. In some embodiments, a system performs the acts of FIG. 9. For example, in one or more embodiments, a system includes one or more memory devices. The system further includes one or more processors that are coupled to the one or more memory devices and configured to cause the system to perform the acts of FIG. 9.

The series of acts 900 includes an act 902 of identifying a fill region for a digital image. For example, in one or more embodiments, the act 902 involves receiving, from a client device, an indication of a fill region. Specifically, in one or more implementations, act 902 comprises receiving user input via a graphical user interface defining a custom, non-rectangular fill region. Act 902, in one or more implementations comprises identifying the fill region for the digital image comprises generating a bounding box about the custom, non-rectangular fill region.

The series of acts 900 also includes an act 904 of intelligently deriving source image bounds from the fill region. In some cases, the act 904 involves an act 906 of expanding a margin of the original bounds of the fill region to generate expanded source image bounds. Furthermore, in some implementations, the act 904 involves an act 908 of modifying an aspect ratio of the expanded source image bounds.

In one or more implementations, act 904 involves intelligently resizing the source image bounds based on one or more parameters of a generative model. For example, act 904 involves identifying input dimensions for the generative model and resizing the source image bounds from original dimensions to the input dimensions.

In one or more implementations, act 904 involves expanding a bounding box about the fill region by a predetermined scalar to generate an expanded source image bounds. Additionally, in one or more implementations, act 904 involves adjusting an aspect ratio of the expanded source image bounds.

In one or more implementations, act 904 involves generating a minimum margin about the fill region. Additionally, in one or more implementations, act 904 involves clipping any portions of the minimum margin that extend beyond edges of the digital image. In one or more implementations, act 904 involves generating an expanded source image bounds by expanding the fill region by a predetermined factor and generating an offset expanded source image bounds by offsetting the expanded source image bounds by maximizing an overlap between the expanded source image bounds and the digital image. Additionally, in one or more implementations, act 904 involves generating clipped expanded source image bounds by clipping portions of the offset expanded source image bounds that extend beyond edges of the digital image. Act 904 optionally involves generating aspect conforming source image bounds by modifying an aspect ratio of the clipped expanded source image bounds to conform to an aspect ratio supported by the generative model. Furthermore, modifying the aspect ratio of the clipped expanded source image bounds optionally involves maintaining an area of the clipped expanded source image bounds. In addition to the foregoing, act 904, in one or more implementations, involves one or more of fitting the aspect conforming source image bounds to an upper limit or fitting aspect conforming source image bounds to cover a lower limit.

Additionally, the series of acts 900 includes an act 910 of generating a content fill, utilizing a generative model, from the resized fill region and the digital image. For example, in one or more implementations, act 910 involves utilizing a diffusion neural network to generate the content fill. In one or more implementations, act 910 involves receiving a text prompt for the content fill and utilizing the diffusion neural network to generate the content fill to have content based on the text prompt.

In one or more implementations act 910 involves scaling the source image defined by the source image bounds and corresponding fill region mask to a size compatible with the generative model. For example, act 910 involve scaling the source image and corresponding fill region mask by a scaling factor.

The series of acts 900 further includes an act 912 of generating a modified digital image utilizing the content fill. In one or more implementations, act 912 involves an act 914 of resizing the content fill. For example, act 914 involves inversely scaling the content fill by the scaling factor. Specifically, in one or more implementations, act 914 involves resizing the content fill by resizing the content fill from the input dimensions to the original dimensions of the fill region.

The series of acts 900, further involves, in one or more implementations, providing a modified digital image that includes the content fill in a location of the fill region of the digital image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that is configurable to perform one or more of the processes described above. One will appreciate that one or more computing devices, such as the computing device 1000 represent the computing devices described above (e.g., the server(s) 102 and/or the client devices 110a-110n) in certain embodiments. In one or more embodiments, the computing device 1000 includes a mobile device (e.g., a mobile telephone, a smartphone, a PDA, a tablet, a laptop, a camera, a tracker, a watch, a wearable device). In some embodiments, the computing device 1000 includes a non-mobile device (e.g., a desktop computer or another type of client device). Further, in some instances, the computing device 1000 includes a server device that includes cloud-based processing and storage capabilities.

As shown in FIG. 10, the computing device 1000 includes one or more processor(s) 1002, memory 1004, a storage device 1006, input/output interfaces 1008 (or “I/O interfaces 1008”), and a communication interface 1010, which are communicatively coupled by way of a communication infrastructure (e.g., bus 1012). While the computing device 1000 is shown in FIG. 10, the components illustrated in FIG. 10 are not intended to be limiting. Additional or alternative components are used in certain embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 retrieve (or fetch) the instructions from an internal register, an internal cache, memory 1004, or a storage device 1006 and decode and execute them.

The computing device 1000 includes memory 1004, which is coupled to the processor(s) 1002. The memory 1004 is used for storing data, metadata, and programs for execution by the processor(s). The memory 1004 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some cases, the memory 1004 includes internal or distributed memory.

The computing device 1000 includes a storage device 1006 including storage for storing data or instructions. As an example, and not by way of limitation, the storage device 1006 can include a non-transitory storage medium described above. In some embodiments, the storage device 1006 includes a hard disk drive (HDD), flash memory, a Universal Serial Bus (USB) drive or a combination of these or other storage devices.

As shown, the computing device 1000 includes one or more I/O interfaces 1008, which are provided to allow a user to provide input to (such as user strokes), receive output from, and otherwise transfer data to and from the computing device 1000. In some implementations, these I/O interfaces 1008 include a mouse, keypad or a keyboard, a touch screen, camera, optical scanner, network interface, modem, other known I/O devices or a combination of such I/O interfaces 1008. In some instances, the touch screen is activated with a stylus or a finger.

In some instances, the I/O interfaces 1008 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. In some implementations, the graphical data is representative of one or more graphical user interfaces and/or any other graphical content that serves a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, in some cases, communication interface 1010 includes a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

In certain implementations, the present invention is embodied in other specific forms without departing from its spirit or essential characteristics. The described embodiments are to be considered in all respects only as illustrative and not restrictive. For example, in some instances, the methods described herein are performed with less or more steps/acts or the steps/acts are performed in differing orders. Additionally, in some embodiments, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
identifying a fill region for a digital image;
intelligently deriving source image bounds based on one or more parameters of a generative model;
generating, utilizing the generative model, a content fill from the source image bounds and the digital image;
resizing the content fill; and
generating a modified digital image including the resized content fill in a location of the fill region of the digital image.

2. The computer-implemented method of claim 1, wherein intelligently deriving the source image bounds based on one or more parameters of the generative model comprises:
identifying input dimensions for the generative model; and
resizing the source image bounds from original dimensions of the fill region to the input dimensions.

3. The computer-implemented method of claim 2, wherein resizing the content fill comprises resizing the content fill from the input dimensions to the original dimensions.

4. The computer-implemented method of claim 1, wherein generating the content fill from the derived source image bounds and the digital image comprises utilizing a diffusion neural network to generate the content fill.

5. The computer-implemented method of claim 4, further comprising:
receiving a text prompt for the content fill; and
utilizing the diffusion neural network to generate the content fill to have content based on the text prompt.

6. The computer-implemented method of claim 1, wherein identifying the fill region for the digital image comprises receiving user input via a graphical user interface defining a custom, non-rectangular fill region.

7. The computer-implemented method of claim 6, wherein identifying the fill region for the digital image comprises generating a bounding box about the custom, non-rectangular fill region.

8. The computer-implemented method of claim 7, wherein intelligently deriving the source image bounds comprises scaling the bounding box by a predetermined scalar to generate expanded source image bounds.

9. The computer-implemented method of claim 8, wherein intelligently deriving the source image bounds comprises adjusting an aspect ratio of the expanded source image bounds.

10. A system comprising:
one or more memory devices; and
one or more processors coupled to the one or more memory devices that cause the system to perform operations comprising:
identifying a fill region for a digital image;
intelligently deriving source image bounds;
generating, utilizing a generative model, a content fill from the source image bounds and the digital image; and
providing a modified digital image that includes the content fill in a location of the fill region of the digital image.

11. The system of claim 10, wherein intelligently deriving the source image bounds comprises:
generating a minimum margin about the fill region; and
clipping any portions of the minimum margin that extend beyond edges of the digital image.

12. The system of claim 10, wherein intelligently deriving the source image bounds further comprises:
generating expanded source image bounds by expanding original bounds of the fill region by a predetermined factor; and
generating offset expanded source image bounds by offsetting the expanded source image bounds by maximizing an overlap between the expanded source image bounds and the digital image.

13. The system of claim 12, wherein intelligently deriving the source image bounds further comprises generating clipped expanded source bounds by clipping portions of the offset expanded source image bounds that extend beyond edges of the digital image.

14. The system of claim 13, wherein intelligently deriving the source image bounds further comprises generating aspect conforming source image bounds by modifying an aspect ratio of the clipped expanded source image bounds to conform to an aspect ratio supported by the generative model.

15. The system of claim 14, wherein modifying the aspect ratio of the clipped expanded source image bounds comprises maintaining an area of the clipped expanded source image bounds.

16. The system of claim 15, wherein intelligently deriving the source image bounds further comprises performing one or more of:
fitting the aspect conforming source image bounds to an upper limit; or
fitting aspect conforming source image bounds to cover a lower limit.

17. A non-transitory computer-readable medium storing instructions thereon that, when executed by at least one processor, cause the at least one processor to perform operations comprising:
displaying a digital image via a graphical user interface;
receiving user input defining a fill region in the digital image;
receiving a text prompt for content to generate in the fill region;
intelligently deriving source image bounds by:
expanding a margin of the fill region to generate expanded source image bounds; and
modifying an aspect ratio of the expanded source image bounds; and
generating, utilizing a generative model from the source image bounds, a modified digital image comprising generated content corresponding to the text prompt in the fill region of the digital image.

18. The non-transitory computer-readable medium of claim 17, wherein intelligently deriving the source image bounds further comprises:
identifying input dimensions supported by the generative model; and
sizing the source image bounds from original dimensions of the fill region to the input dimensions.

19. The non-transitory computer-readable medium of claim 18, wherein generating the modified digital image comprises resizing a content fill generated by the generative model comprises from the input dimensions to the original dimensions.

20. The non-transitory computer-readable medium of claim 17, wherein receiving user input defining a fill region in the digital image comprises receiving the user input, via a graphical user interface, the user input defining a custom, non-rectangular fill region.
